(19) United States
(12) Patent Application Publication
(10) Pub. No.: US 2019/0362062 A1
(43) Pub. Date: Nov. 28, 2019

(54) BIOMETRIC AUTHENTICATION APPARATUS AND BIOMETRIC AUTHENTICATION METHOD

(71) Applicant: FUJITSU FRONTECH LIMITED, Tokyo (JP)

(72) Inventors: Yuki HASEGAWA, Inagi (JP); Asato UCHIYAMA, Inagi (JP); Katsumi IDE, Inagi (JP); Isao IWAGUCHI, Inagi (JP); Kentarou KASUGAI, Inagi (JP); Kozo YAMAZAKI, Inagi (JP)

(21) Appl. No.: 16/535,694

(22) Filed: Aug. 8, 2019

Related U.S. Application Data
(63) Continuation of application No. PCT/JP2017/006952, filed on Feb. 23, 2017.

(51) Int. Cl. G06F 21/32; G06K 9/00; G06K 9/62; G06T 7/70

(52) U.S. Cl. CPC G06F 21/32; G06K 9/00362; G06K 9/6202; G06K 2009/00932; G06K 9/00926; G06T 2207/30196; G06T 7/70

(57) ABSTRACT

A a body-site image obtained by capturing an image of a body site of a user is acquired. On the basis of the acquired body-site image, the orientation of the body site within the body-site image is detected. A template pattern conforming with the detected orientation is extracted from a template-pattern storage unit storing a plurality of template patterns. The acquired body-site image is converted into a body-site pattern obtained by extracting characteristic information from the body-site image. Authentication of the user is performed by comparing the body-site pattern obtained as a result of the converting and the extracted template pattern, thereby allowing appropriate personal authentication to be performed even when the orientation of a hand held over an imaging apparatus and the orientation of the imaging apparatus in registering vein data are different from those in performing authentication.

### CROSS-REFERENCE TO RELATED APPLICATIONS

This application is continuation application of International Application PCT/JP2017/006952 filed on Feb. 23, 2017 and designated the U.S., the entire contents of which are incorporated herein by reference.

### FIELD

The present invention relates to a biometric authentication program, biometric authentication apparatus, and biometric authentication method for performing personal authentication by using human body sites.

### BACKGROUND

Biometric authentication techniques for performing personal authentication by using human body sites have conventionally been known. A biometric authentication technique is a technique wherein body-site information indicating characteristics of a human body site is registered in advance to perform personal authentication by assessing the similarity between the registered body-site information and body-site information obtained in an authentication process.

Human body sites include many portions with which a person can be identified, such as fingerprints, palm prints, iris, retina, face, and veins. Various biometric authentication apparatuses for performing personal authentication by recognizing characteristics of a human body site have been provided with the development of biometrics technology in recent years. In particular, veins, which can provide a relatively large amount of data on characteristics of a person and exhibit no changes for the entirety of one's life, including the fetal period, are suitable for personal authentication (see, for example, Japanese Laid-open Patent Publication Nos. 2009-282706 and 2013-206002).

For example, when personal authentication is performed using palm veins, the user may bring his/her palm close to a biometric authentication apparatus during registration of vein data and during authentication. The biometric authentication apparatus irradiates the palm with, for example, near infrared light having a wavelength of about 760 nanometers (nm). Then, the biometric authentication apparatus receives reflected light from the palm by means of a sensor. The hemoglobin within red blood cells flowing through the veins (reduced hemoglobin) contains no oxygen and absorbs near infrared light having a wavelength of about 760 nm. Hence, when the palm is irradiated with near infrared rays, only little light is reflected from portions with veins so that vein positions can be determined in accordance with the intensity of reflected near infrared rays. Such biometric authentication techniques using veins have started to become widely available in fields that involve high level of security, e.g., the fields of personal authentication at financial institutions such as banks and personal authentication when entering or leaving a facility required to be tightly controlled.

The biometric authentication techniques using veins have another feature wherein authentication can be performed through a simple non-contact operation. Hence, in recent years, such techniques have been increasingly applied as substitutes for passwords for logging in to personal computers (PC) and tablets and for managing access to a network by using such PCs and the like. The biometric authentication techniques that rely on PCs and the like may use a portable, miniature imaging apparatus that has a function for emitting a near infrared ray and receiving reflected light by means of a sensor. FIGS. 11 and 12 depict examples of imaging apparatuses.

FIG. 11 illustrates a cable-installed imaging apparatus as an exemplary imaging apparatus.

A cable-installed imaging apparatus 100A has a function for emitting a near infrared ray to a palm held thereover and receiving reflected light from the palm by means of a sensor (function for capturing image data). As depicted in FIG. 11, the cable-installed imaging apparatus 100A includes a universal-serial-bus (USB) male connector 110 for establishing a connection to a PC or the like. The cable-installed imaging apparatus 100A can be connected to a USB female connector of a PC or the like by a data communication cable such as a USB cable 120 for a data communication.

For example, the cable-installed imaging apparatus 100A may include imaging elements such as charge-coupled-device (CCD) image sensors or complementary-metal-oxide-semiconductor (CMOS) image sensors arranged at equal intervals in a longitudinal direction (Y direction) and a lateral direction (X direction). Image data captured by the cable-installed imaging apparatus 100A is represented as two-dimensional data in the X direction and the Y direction with a predetermined position as an origin.

FIG. 12 illustrates a cableless imaging apparatus as an exemplary imaging apparatus.

A cableless imaging apparatus 100B has a function for emitting a near infrared ray and receiving reflected light by means of a sensor. As depicted in FIG. 12, the cableless imaging apparatus 100B includes a USB male connector 110 for establishing a connection to a PC or the like. The cableless imaging apparatus 100B can be directly connected to a USB female connector of a PC or the like for a data communication.

For example, the cableless imaging apparatus 100B may include imaging elements such as CCDs or CMOSs arranged at equal intervals in a longitudinal direction (Y direction) and a lateral direction (X direction). Image data captured by the cableless imaging apparatus 100B is represented as two-dimensional data in the X direction and the Y direction with a predetermined position as an origin.

However, biometric authentication using a portable, miniature imaging apparatus has had problems described in the following that pertain to a relationship between the orientation of a hand held over the imaging apparatus and the orientation of the imaging apparatus.

FIGS. 13 and 14 are explanatory diagrams for problems with use of a cable-installed imaging apparatus.

As depicted in FIGS. 13 and 14, the cable-installed imaging apparatus 100A described above by referring to FIG. 11 is data-communicably connected to a PC 200 by inserting the USB male connector 110 into a USB female connector 210 provided on a side surface of the PC 200.

Assume that in registering vein data, the orientation of a hand 300 and the orientation of the cable-installed imaging apparatus 100A have therebetween an arrangement relationship such as that depicted in FIG. 13 and in authentication, the orientation of the hand 300 and the orientation of the cable-installed imaging apparatus 100A have therebetween an arrangement relationship such as that depicted in FIG. 14. In this case, pieces of image data captured by the cable-installed imaging apparatus 100A are pieces of information different from each other by an angle of 90°. As a result, the authentication will fail even though the hand 300 in the registering is the same as the hand 300 in the authentication.

FIG. 15 is an explanatory diagram for problems with use of a cableless imaging apparatus.

As depicted in FIG. 15, the cableless imaging apparatus 100B described above by referring to FIG. 12 is data-communicably connected to the PC 200 by inserting the USB male connector 110 into any one of USB female connectors 210, 220, 230, and 240 provided on side surfaces of the PC 200.

Assume that in registering vein data, the USB male connector 110 of the cableless imaging apparatus 100B is inserted into the USB female connector 210 and in authentication, the USB male connector 110 of the cableless imaging apparatus 100B is inserted into any one of the USB female connectors 220, 230, and 240. In this case, pieces of image data captured by the cableless imaging apparatus 100B are pieces of information different from each other by an angle of 90°, 180°, or 270°. As a result, the authentication will fail even though the hand 300 in the registering is the same as the hand 300 in the authentication.

The present invention was created in view of the situations described above. An object of the present invention is to provide a biometric authentication program, biometric authentication apparatus, and biometric authentication method for allowing appropriate personal authentication to be performed even when the orientation of a hand held over the imaging apparatus and the orientation of the imaging apparatus in registering vein data are different from those in performing authentication.

### SUMMARY

A biometric authentication program of the present invention is one for causing a computer of a biometric authentication apparatus to function as: a body-site-image acquisition means for acquiring a body-site image obtained by capturing an image of a body site of a user; an orientation detection means for detecting, on the basis of the body-site image acquired by the body-site-image acquisition means, the orientation of the body site within the body-site image; a template-pattern extraction means for extracting a template pattern conforming with the orientation detected by the orientation detection means from a template-pattern storage unit storing a plurality of template patterns; an image conversion means for converting the body-site image acquired by the body-site-image acquisition means into a body-site pattern obtained by extracting characteristic information from the body-site image; and an authentication means for performing authentication of the user by comparing the body-site pattern obtained by the image conversion means as a result of the converting and the template pattern extracted by the template-pattern extraction means.

The biometric authentication program of the invention is desirably such that the template-pattern storage unit stores template patterns obtained by extracting characteristic information from individual template images associated with a plurality of orientations of the body site of the user.

The biometric authentication program of the invention is also desirably such that the template pattern is obtained by converting a body-site image associated with one orientation of the body site of the user.

The biometric authentication program of the invention is also desirably such that the plurality of orientations are orientations corresponding to four different directions extending from the same point and arranged in a cross formation forming four right angles.

The biometric authentication program of the invention is also desirably such that the body site is a palm, the body-site image is a palm image, and the orientation detection means detects the orientation of the palm on the basis of a finger portion and a wrist portion included in the palm image.

The biometric authentication program of the invention is also desirably such that the body-site image is a vein image captured using reflected light resulting from infrared light irradiating the palm.

The biometric authentication program of the invention is also desirably such that the characteristic information includes the position, type, direction, or length of an end point or branch point within the vein image.

The biometric authentication program of the invention also desirably causes the computer to function as a template-pattern registration means for storing the body-site pattern obtained by the image conversion means as a result of the converting in the template-pattern storage unit in advance as a template pattern.

A biometric authentication apparatus of the invention includes: a body-site-image acquisition unit that acquires a body-site image obtained by capturing an image of a body site of a user; an orientation detection unit that detects, on the basis of the body-site image acquired by the body-site-image acquisition unit, the orientation of the body site within the body-site image; a template-pattern extraction unit that extracts a template pattern conforming with the orientation detected by the orientation detection unit from a template-pattern storage unit storing a plurality of template patterns; an image conversion unit that converts the body-site image acquired by the body-site-image acquisition unit into a body-site pattern obtained by extracting characteristic information from the body-site image; and an authentication unit that performs authentication of the user by comparing the body-site pattern obtained by the image conversion unit as a result of the converting and the template pattern extracted by the template-pattern extraction unit.

A biometric authentication method of the invention is implemented by a biometric authentication apparatus and includes: acquiring a body-site image obtained by capturing an image of a body site of a user; detecting, on the basis of the acquired body-site image, the orientation of the body site within the body-site image; extracting a template pattern conforming with the detected orientation from a template-pattern storage unit storing a plurality of template patterns; converting the acquired body-site image into a body-site pattern obtained by extracting characteristic information from the body-site image; and performing authentication of the user by comparing the body-site pattern obtained as a result of the converting and the extracted template pattern.

### BRIEF DESCRIPTION OF DRAWINGS

FIG. 1 is a hardware configuration diagram of a biometric authentication apparatus in accordance with embodiments;

FIG. 2 is a functional block diagram of a biometric authentication apparatus in accordance with embodiments;

FIG. 3 is a hardware configuration diagram of an imaging apparatus in accordance with embodiments;

FIG. 4 is a flowchart illustrating the flow of a biometric authentication process in accordance with embodiments;

FIG. 5 illustrates an example of a palm image;

FIG. 6 illustrates an example of detection of the orientation of a palm (case 1);

FIG. 7 illustrates an example of detection of the orientation of a palm (case 2);

FIG. 8 illustrates an example of a vein image;

FIG. 9 is a flowchart illustrating the flow of a body-site registration process;

FIG. 10 illustrates an example of a template-pattern storage unit;

FIG. 11 illustrates a cable-installed imaging apparatus as an exemplary imaging apparatus;

FIG. 12 illustrates a cableless imaging apparatus as an exemplary imaging apparatus;

FIG. 13 is an explanatory diagram for problems with use of a cable-installed imaging apparatus (case 1);

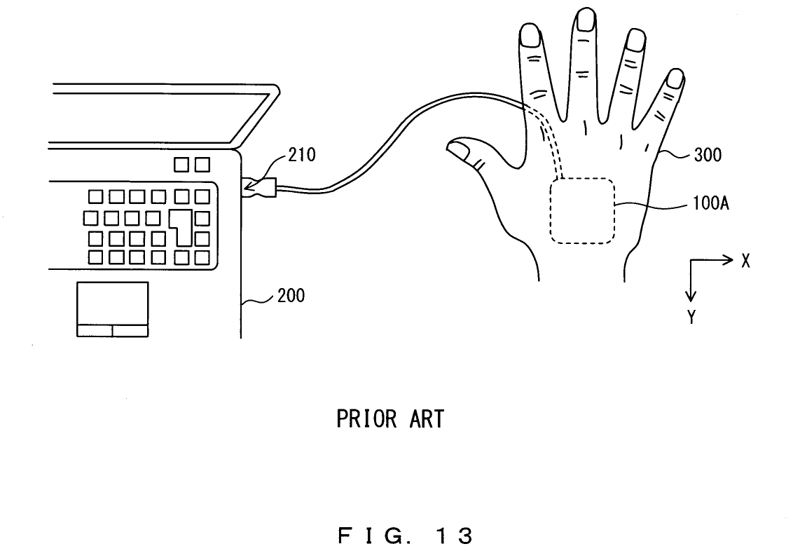

FIG. 14 is an explanatory diagram for problems with use of a cable-installed imaging apparatus (case 2); and

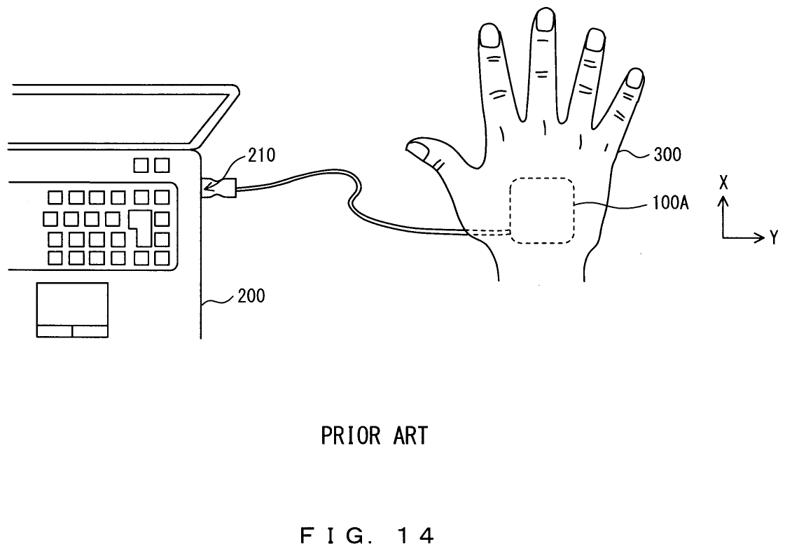

FIG. 15 is an explanatory diagram for problems with use of a cableless imaging apparatus.

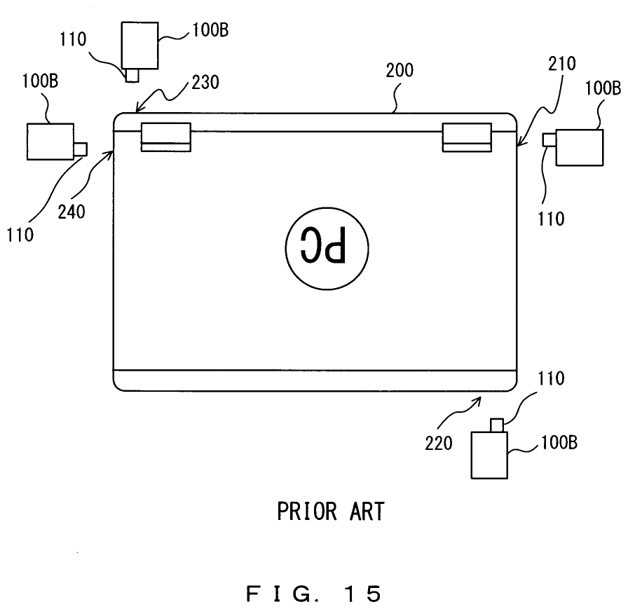

### DETAILED DESCRIPTION OF THE PREFERRED EMBODIMENTS

The following describes embodiments of the present invention in detail by referring to the drawings.

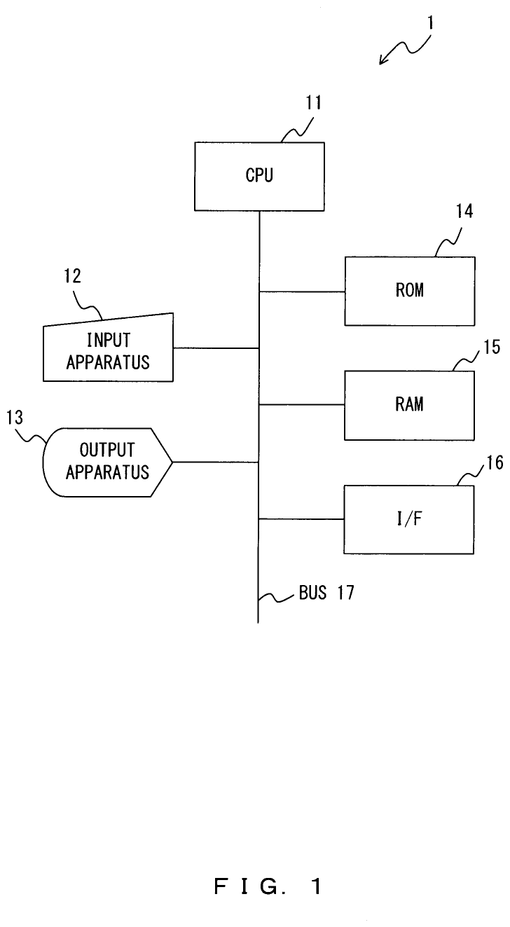

FIG. 1 is a hardware configuration diagram of a biometric authentication apparatus in accordance with embodiments.

A biometric authentication apparatus 1 may be configured by installing a program for performing a biometric authentication process (this process will be described hereinafter) in a general-purpose PC.

As depicted in FIG. 1, the biometric authentication apparatus 1 includes a central processing unit (CPU) 11, an input apparatus 12, an output apparatus 13, a read only memory (ROM) 14, a random access memory (RAM) 15, and an interface (I/F) 16, all of which are connected to a bus 17.

The input apparatus 12 is, for example, a keyboard, a joystick, a light pen, a mouse, a touch pad, a touch panel, or a trackball and is used to input various data or signals.

The output apparatus 13 is, for example, a display such as a liquid crystal display (LCD) or a printer and is used to output images or information.

The ROM 14 stores a program to be executed by the biometric authentication apparatus 1 so as to perform a biometric authentication process as well as control programs and table data for controlling and executing functions of the biometric authentication apparatus 1.

The RAM 15 stores frame buffers for the output apparatus 13 and some application programs.

The interface 16 is a unit for establishing a connection to an external device, e.g., a serial interface such as a USB interface or a parallel interface such as an Ethernet interface.

The CPU 11 controls these components.

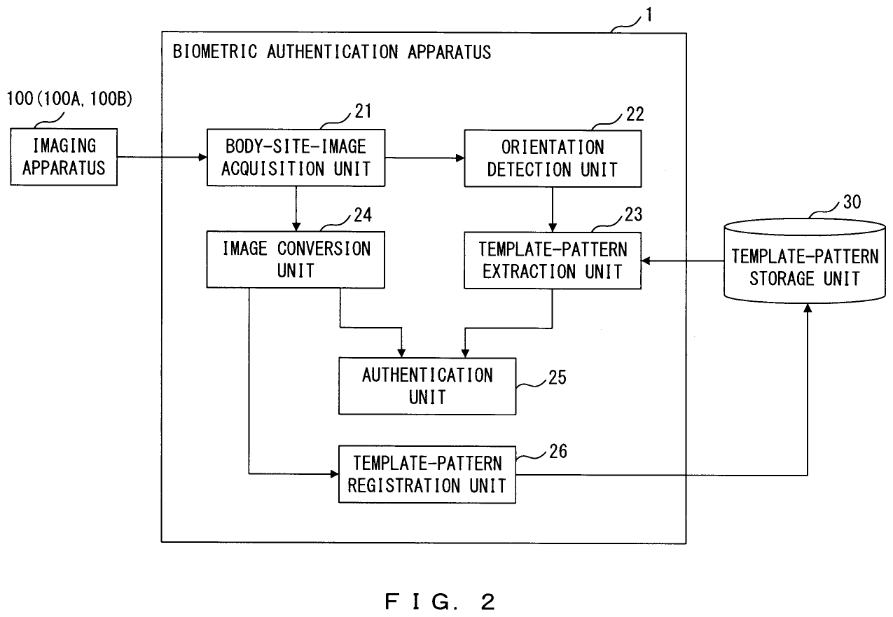

FIG. 2 is a functional block diagram of a biometric authentication apparatus in accordance with embodiments.

As depicted in FIG. 2, the biometric authentication apparatus 1 includes a body-site-image acquisition unit 21, an orientation detection unit 22, a template-pattern extraction unit 23, an image conversion unit 24, an authentication unit 25, and a template-pattern registration unit 26. The biometric authentication apparatus 1 has functions of a computer and performs a biometric authentication process (this process will be described hereinafter) in accordance with a biometric authentication program installed therein.

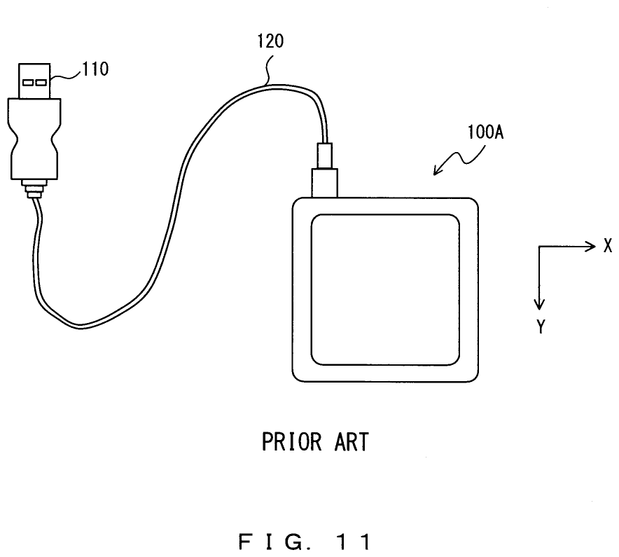

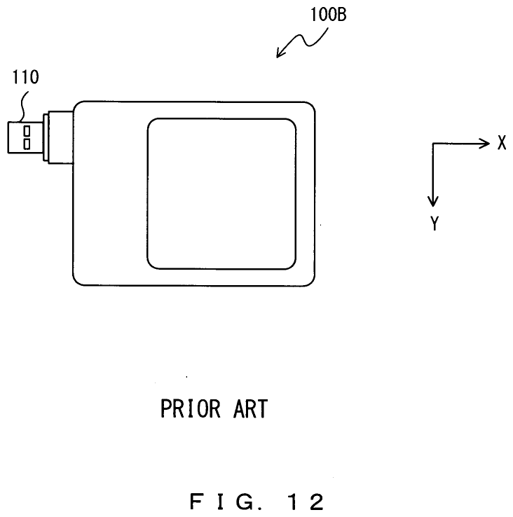

The body-site-image acquisition unit 21 acquires a body-site image of a user captured by the cable-installed imaging apparatus 100A described above with reference to FIG. 11 or the cableless imaging apparatus 100B described above with reference to FIG. 12. The body site is, for example, a palm. Both the cable-installed imaging apparatus 100A and the cableless imaging apparatus 100B will hereinafter be referred to as an imaging apparatus 100.

On the basis of the body-site image acquired by the body-site-image acquisition unit 21, the orientation detection unit 22 detects the orientation of the body site within the body-site image. When the body site is a palm, the body-site image is a palm image. For example, the orientation detection unit 22 may detect the orientation of the palm on the basis of a middle finger portion and a wrist portion included in the palm image.

The template-pattern extraction unit 23 extracts a template pattern conforming with the orientation detected by the orientation detection unit 22 from a template-pattern storage unit 30 storing a plurality of template patterns. The template-pattern storage unit 30 stores template patterns obtained by extracting characteristic information from individual template images associated with a plurality of orientations of the body site of the user, e.g., orientations corresponding to four different directions extending from the same point and arranged in a cross formation forming four right angles. For example, the characteristic information may include the position, type, direction, and length of an end point or branch point of a vein. The template-pattern storage unit 30 may be included in the biometric authentication apparatus 1 or may be stored by an external storage apparatus.

The image conversion unit 24 converts the body-site image acquired by the body-site-image acquisition unit 21 into a body-site pattern obtained by extracting characteristic information from the body-site image. For example, a vein image may be generated from the palm image by performing noise removal processing, binarization processing, and thinning processing. Then, the position, type, direction, length, or the like of a characteristic point within the vein image is calculated as the body-site pattern.

The authentication unit 25 performs authentication of the user by comparing the body-site pattern obtained by the image conversion unit 24 as a result of the converting and the template pattern extracted by the template-pattern extraction unit 23.

The template-pattern registration unit 26 stores the body-site pattern obtained by the image conversion unit 24 as a result of the converting in the template-pattern storage unit 30 in advance as a template pattern.

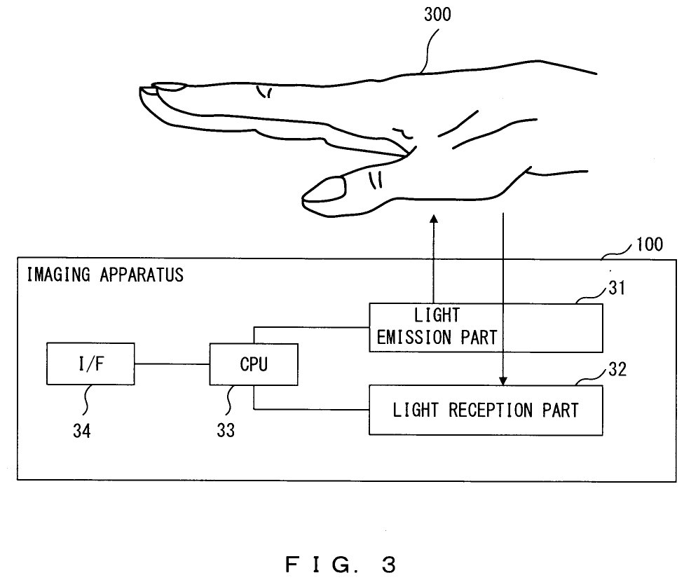

FIG. 3 is a hardware configuration diagram of an imaging apparatus in accordance with embodiments.

As depicted in FIG. 3, the imaging apparatus 100 includes a light emission part 31, a light reception part 32, a CPU 33, and an interface 34.

For example, the light emission part 31 may include a light emitting diode (LED) and emit irradiation light to irradiate the hand 300. The irradiation light is, for example, near infrared light having a wavelength of about 760 nm.

Irradiation light emitted from the light emission part 31 irradiates the palm of the hand 300 and is then scattered within the hand 300. The light reception part 32 receives, as reflected light, a portion of the irradiation light that was scattered within the hand 300. The light reception part 32 is, for example, an image sensor for near infrared light and includes a plurality of light reception elements arranged in a matrix formation. Each light reception element converts reflected light into an electric signal (light reception signal) having a signal level that depends on the quantity of the reflected light.

The CPU 33 controls activation and deactivation of the light emission part 31. The CPU 33 reads light reception signals from the individual light reception elements of the light reception part 32 and generates a vein image on the basis of the read light reception signals that correspond to one frame. The reduced hemoglobin flowing through the veins absorbs near infrared light, and hence an image of the vein portion located under the palmar skin will be darker than an image of tissues located in the vicinity of this vein portion. A pattern based on the difference in brightness will be a vein image.

The interface 34 is a unit for establishing a connection to an external device, e.g., a serial interface such as a USB interface or a parallel interface such as an Ethernet interface. For example, the interface 34 may be connected to the biometric authentication apparatus 1.

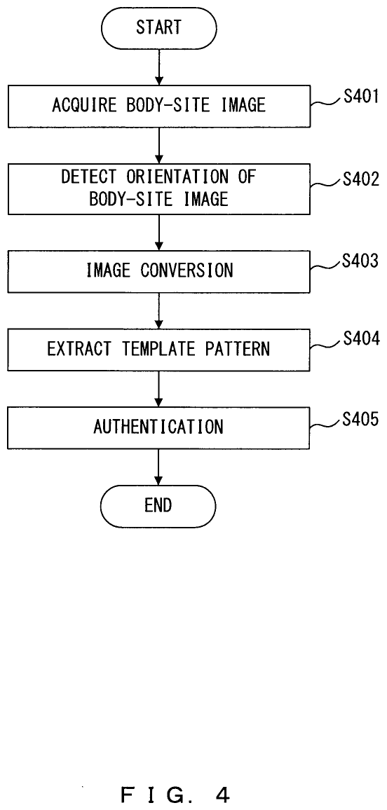

The following describes the biometric authentication process performed by the biometric authentication apparatus 1 by referring to FIGS. 4-8.

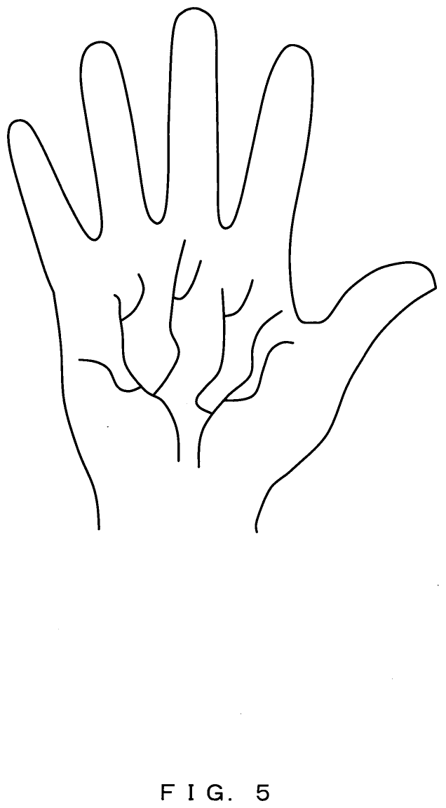

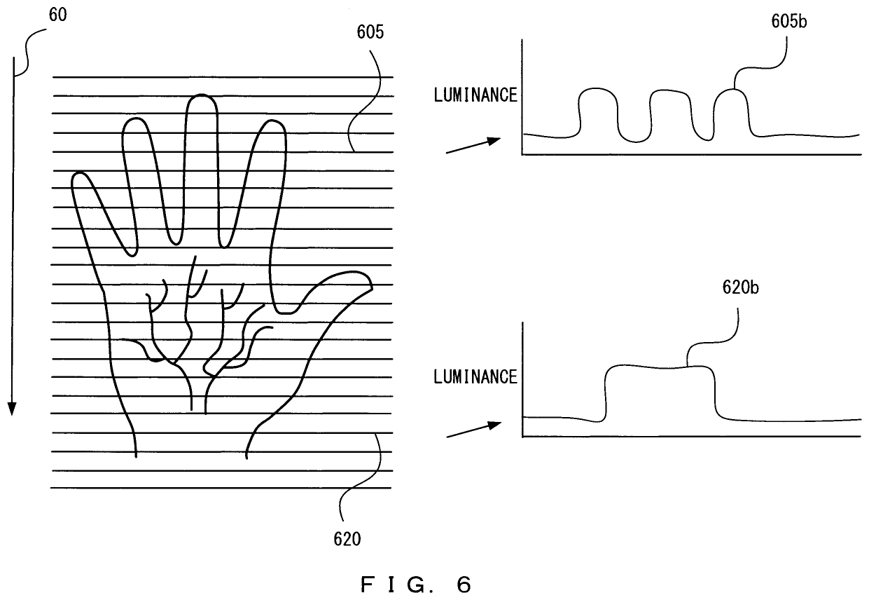

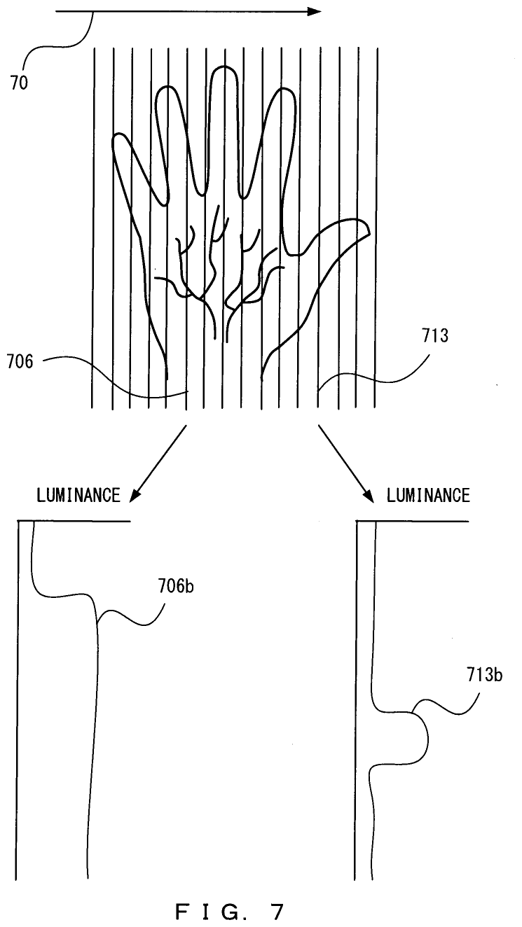

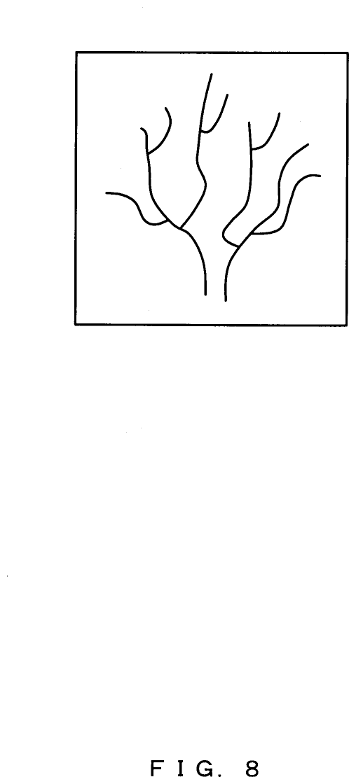

FIG. 4 is a flowchart illustrating the flow of a biometric authentication process in accordance with embodiments. FIG. 5 illustrates an example of a palm image. FIGS. 6 and 7 each illustrate an example of detection of the orientation of a palm. FIG. 8 illustrates an example of a vein image.

In step S401 in FIG. 4, the CPU 11 of the biometric authentication apparatus 1 acquires a body-site image of a user captured by the imaging apparatus 100, e.g., a palm image such as that depicted in FIG. 5.

In step S402, the CPU 11 detects, on the basis of the body-site image acquired in step S401, detects the orientation of a body site within the body-site image. When the body-site image is a palm image, CPU 11 detects the orientation of the palm on the basis of, for example, a middle finger portion and a wrist portion included in the palm image. For example, the palm image may be scanned in a first scanning direction 60 as depicted in FIG. 6, and the palm image may be scanned in a second scanning direction 70 as depicted in FIG. 7, wherein the first scanning direction 60 and the second scanning direction 70 are different by an angle of 90°. The orientation of the palm is detected by comparing a luminance curve 605b associated with a scanning line 605 with a luminance curve 620b associated with a scanning line 620 and by comparing a luminance curve 706b associated with a scanning line 706 with a luminance curve 713b associated with a scanning line 713. In this example, it can be detected that the wrist is located on the scanning-line-620 side in the first scanning direction 60.

In step S403, the CPU 11 converts the body-site image acquired in step S401 into a body-site pattern obtained by extracting characteristic information from the body-site image. For example, a vein image such as that depicted in FIG. 8 may be generated from the palm image by performing noise removal processing such as smoothing relying on a lowpass filter or image enhancement relying on a highpass filter, binarization processing for providing a black-and-white image by eliminating an image contrast, and thinning processing for causing individual linked objects included in the binary image to each have a line width of one pixel. Then, for the vein image, for example, characteristic points, such as end points indicating the ends of veins and branch points that are junctions between veins, may be detected, and the positions, types, directions, lengths, or the like of the characteristic points may be calculated as a body-site pattern.

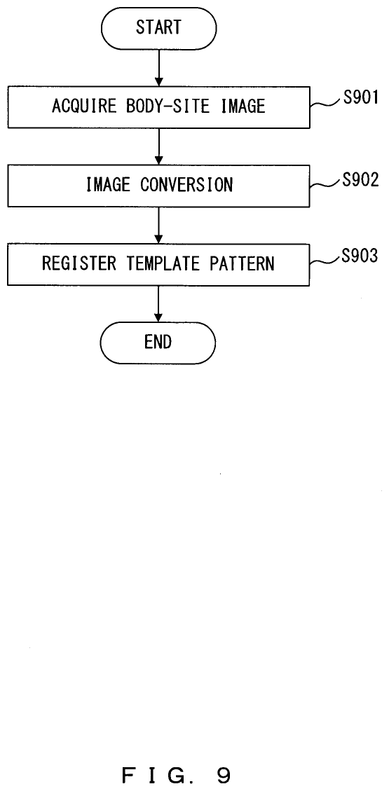

In step S404, the CPU 11 extracts a template pattern conforming with the orientation detected in step S402 from the template-pattern storage unit 30 that stores a plurality of template patterns. The template-pattern storage unit 30 stores template patterns obtained by extracting characteristic information from individual template images associated with a plurality of orientations of the body site of the user, e.g., orientations corresponding to four different directions extending from the same point and arranged in a cross formation forming four right angles. A body-site registration process for registering a template pattern in the template-pattern storage unit 30 will be described hereinafter by referring to FIG. 9.

In step S405, the CPU 11 performs authentication of the user by comparing the body-site pattern obtained as a result of the converting in step S403 and the template pattern extracted in step S404. For example, when the similarity between the body-site pattern and the template pattern is equal to or greater than a preset threshold, it may be determined that the user corresponding to the body-site image acquired in step S401 is a person registered as corresponding to the template pattern extracted in step S404. The comparison-based similarity may be determined using, for example, minutia matching or pattern matching. To determine the comparison-based similarity by using minutia matching, first, the number of pairs of identical minutiae (characteristic points) included in the template pattern and the body-site pattern is determined. Then, the similarity can be calculated by dividing the determined number of pairs of identical minutiae by the number of minutiae included in the body-site pattern.

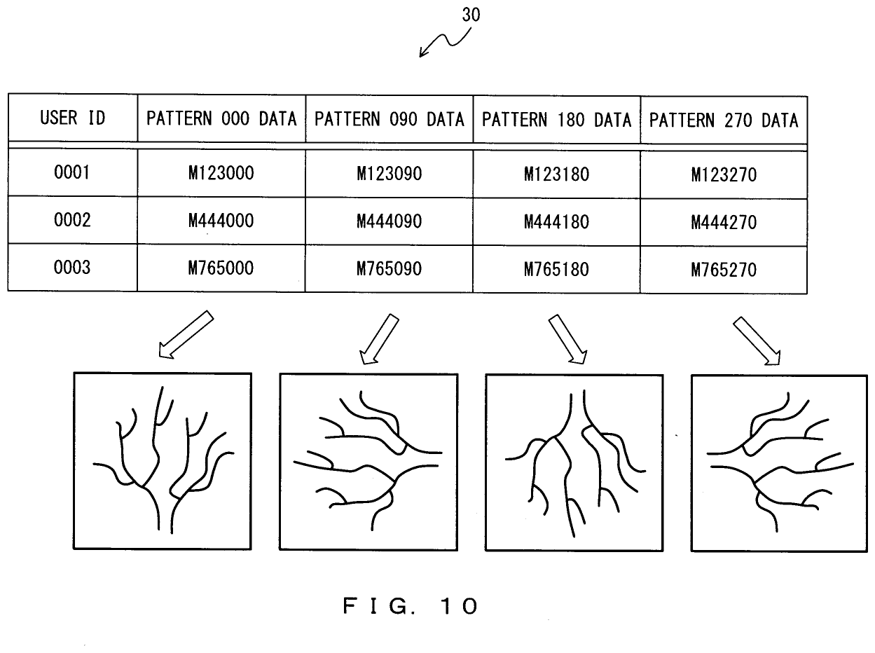

The following describes the body-site registration process performed by the biometric authentication apparatus 1 by referring to FIGS. 9 and 10.

FIG. 9 is a flowchart illustrating the flow of the body-site registration process. FIG. 10 illustrates an example of a template-pattern storage unit.

In step S901 in FIG. 9, the CPU 11 of the biometric authentication apparatus 1 acquires a body-site image of a user captured by the imaging apparatus 100, e.g., a palm image, as seen in step S401 in FIG. 4.

In step S902, the CPU 11 converts the body-site image acquired in step S901 and a body-site image associated with an angle different from the angle with which the former body-site image is associated into body-site patterns obtained by extracting characteristic information from these body-site images, as seen in step S403 in FIG. 4. For example, the body-site image acquired in step S901 and body-site images associated with three directions different from the direction with which the former body-site image is associated by angles of 90°, 180°, and 270°, i.e., body-site images associated with four directions, may be converted into body-site patterns.

In step S903, the CPU 11 stores, as template patterns, the body-site patterns obtained as a result of the converting in step S902 in the template-pattern storage unit 30. For example, as depicted in FIG. 10, “pattern 000 data”, “pattern 090 data”, “pattern 180 data”, and “pattern 270 data” may be stored in association with a user ID for identifying the user, wherein the “pattern 000 data” is a body-site pattern obtained by converting the acquired body-site image, the “pattern 090 data” is a body-site pattern obtained by converting the body-site image associated with an orientation different by an angle of 90° from the orientation with which the acquired body-site image is associated, the “pattern 180 data” is a body-site pattern obtained by converting the body-site image associated with an orientation different by an angle of 180° from the orientation with which the acquired body-site image is associated, and the “pattern 270 data” is a body-site pattern obtained by converting the body-site image associated with an orientation different by an angle of 270° from the orientation with which the acquired body-site image is associated.

As described above, one body-site image may be converted into four template patterns. Alternatively, body-site images associated with four directions may be acquired and converted into template patterns.

Although embodiments of the present invention have been described with reference to the drawings, the biometric authentication apparatus of the present invention is not limited to the described embodiments.

In the above-described embodiments of the invention, a function of the biometric authentication apparatus may be implemented by hardware or firmware or software installed in a digital signal processor (DSP) board or a CPU board.

Needless to say, as long as the functions of the biometric authentication apparatus of the invention can be implemented, the biometric authentication apparatus is not limited to the embodiments described above and may be a single apparatus, a system or integrated apparatus provided with a plurality of apparatuses, or a system wherein processing is performed over a network such as a LAN or a WAN.

The biometric authentication apparatus may be implemented by a system provided with a CPU connected to a bus, memories such as ROMs and RAMs, an input apparatus, an output apparatus, an external recording apparatus, a medium driving apparatus, and a network connection apparatus. Accordingly, it will not be surprising that the functions of the present invention can be implemented by providing the biometric authentication apparatus with a memory, such as a ROM or a RAM, external recording apparatus, or transportable recording medium having recorded therein a software program for implementing the system in accordance with the described embodiments so that the computer of the biometric authentication apparatus can read and execute the program.

In this case, the program read from the transportable recording medium or the like implements the novel functions of the invention, and thus the transportable recording medium or the like having the program recorded therein provides the present invention.

For example, the transportable recording medium for providing programs may be a flexible disk, a hard disk, an optical disc, a magnetooptical disk, a CD-ROM, a CD-R, a DVD-ROM, a DVD-RAM, magnetic tape, a nonvolatile memory card, a ROM card, or any type of recording medium that has data recorded therein via a network connection apparatus (i.e., a communication line) for electronic mails, PC communications, and the like.

A computer (information processing apparatus) may execute a program loaded into a memory so as to implement the functions of the embodiments described above. In addition, an OS and the like operated on the computer may perform some of or all of the actual processing operations on the basis of an instruction based on the program, and the functions of the embodiments described above may be implemented by these processing operations.

Moreover, a program read from the transportable recording medium or a program (data) provided by a program (data) creator may be written to a functionality expansion board inserted into a computer or a memory provided for a functionality expansion unit connected to the computer. Then, a CPU and the like provided at the functionality expansion board or the functionality expansion unit may perform some of or all of the actual processing operations on the basis of an instruction based on the program, and the functions of the embodiments described above may be implemented by these processing operations.

Accordingly, the present invention is not limited to the above-described embodiments and may have various configurations or shapes without departing from the gist of the thereof.

### EXPLANATIONS OF LETTERS OR NUMERALS

1: Biometric authentication apparatus
11: CPU
12: Input apparatus
13: Output apparatus
14: ROM
15: RAM
16: Interface (I/F)
17: Bus
21: Body-site-image acquisition unit
22: Orientation detection unit
23: Template-pattern extraction unit
24: Image conversion unit
25: Authentication unit
26: Template-pattern registration unit
30: Template-pattern storage unit
31: Light emission part
32: Light reception part
33: CPU
34: Interface (I/F)
60: First scanning direction
70: Second scanning direction
100: Imaging apparatus
100A: Cable-installed imaging apparatus
100B: Cableless imaging apparatus
110: USB male connector
120: USB cable
200: PC
210, 220, 230, 240: USB female connector
300: Hand
605, 620: Scanning line
605b, 620b: Luminance curve
706, 713: Scanning line
706b, 713b: Luminance curve

What is claimed is:

1. A non-transitory computer-readable recording medium having stored therein a program that causes a computer of a biometric authentication apparatus to function as
a body-site-image acquisition means for acquiring a body-site image obtained by capturing an image of a body site of a user,
an orientation detection means for detecting, on the basis of the body-site image acquired by the body-site-image acquisition means, an orientation of the body site within the body-site image,
a template-pattern extraction means for extracting a template pattern conforming with the orientation detected by the orientation detection means from a template-pattern storage unit storing a plurality of template patterns,
an image conversion means for converting the body-site image acquired by the body-site-image acquisition means into a body-site pattern obtained by extracting characteristic information from the body-site image, and
an authentication means for performing authentication of the user by comparing the body-site pattern obtained by the image conversion means as a result of the converting and the template pattern extracted by the template-pattern extraction means.

2. The non-transitory computer-readable recording medium of claim 1, wherein
the template-pattern storage unit stores template patterns obtained by extracting characteristic information from individual template images associated with a plurality of orientations of the body site of the user.

3. The non-transitory computer-readable recording medium of claim 2, wherein
the template pattern is obtained by converting a body-site image associated with one orientation of the body site of the user.

4. The non-transitory computer-readable recording medium of claim 3, wherein
the plurality of orientations are orientations corresponding to four different directions extending from the same point and arranged in a cross formation forming four right angles.

5. The non-transitory computer-readable recording medium of claim 1, wherein
the body site is a palm,
the body-site image is a palm image, and
the orientation detection means detects the orientation of the palm on the basis of a finger portion and a wrist portion included in the palm image.

6. The non-transitory computer-readable recording medium of claim 5, wherein
the body-site image is a vein image captured using reflected light resulting from infrared light irradiating the palm.

7. The non-transitory computer-readable recording medium of claim 6, wherein
the characteristic information includes a position, type, direction, or length of an end point or branch point within the vein image.

8. The non-transitory computer-readable recording medium of claim 1, causing the computer to function as a template-pattern registration means for storing the body-site pattern obtained by the image conversion means as a result of the converting in the template-pattern storage unit in advance as a template pattern.

9. A biometric authentication apparatus comprising:
a body-site-image acquisition unit that acquires a body-site image obtained by capturing an image of a body site of a user;
an orientation detection unit that detects, on the basis of the body-site image acquired by the body-site-image acquisition unit, an orientation of the body site within the body-site image;
a template-pattern extraction unit that extracts a template pattern conforming with the orientation detected by the orientation detection unit from a template-pattern storage unit storing a plurality of template patterns;
an image conversion unit that converts the body-site image acquired by the body-site-image acquisition unit into a body-site pattern obtained by extracting characteristic information from the body-site image; and
an authentication unit that performs authentication of the user by comparing the body-site pattern obtained by the image conversion unit as a result of the converting and the template pattern extracted by the template-pattern extraction unit.

10. A biometric authentication method implemented by a biometric authentication apparatus, the biometric authentication method comprising:
acquiring a body-site image obtained by capturing an image of a body site of a user;
detecting, on the basis of the acquired body-site image, an orientation of the body site within the body-site image;
extracting a template pattern conforming with the detected orientation from a template-pattern storage unit storing a plurality of template patterns;
converting the acquired body-site image into a body-site pattern obtained by extracting characteristic information from the body-site image; and
performing authentication of the user by comparing the body-site pattern obtained as a result of the converting and the extracted template pattern.
